(19) United States
(12) Patent Application Publication
(10) Pub. No.: US 2002/0156733 A1
(43) Pub. Date: Oct. 24, 2002

(54) Business management support method and business management support program

(75) Inventors: Takashi Shimada, Kawasaki (JP); Haruo Hira, Kawasaki (JP); Kunihiro Shibata, Kawasaki (JP); Katsumi Nakano, Kawasaki (JP); Muneichi Tsujibayashi, Izumi (JP); Hiroshi Takahashi, Sakai (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/974,823

(22) Filed: Oct. 12, 2001

(30) Foreign Application Priority Data
Apr. 23, 2001 (JP) 2001-123918

(51) Int. Cl. G06F 17/60

(52) U.S. Cl. 705/42

(57) ABSTRACT

Computers of a service provider, a service beneficiary, a service intermediary and an intellectual service cooperator are connected via an internet 14 with one another. To support the management, the service provider provides to the service beneficiary the results of consultation which the intellectual service cooperator has been requested to make, in the form of follow information by way of a bank which is the service intermediary.

### BACKGROUND OF THE INVENTION

1. Field of the Invention

The present invention relates generally to a business management support method and a business management support program for providing a business support service from a service provider via a service intermediary to a service beneficiary by use of computers in a network environment, and more particularly to a business management support method and a business management support program for providing a business support service to the service beneficiary by way of a bank acting as the service beneficiary.

2. Description of the Related Arts

Up until now, business entities providing intellectual services such as management consultation or audit have been subdivided into a management consulting company, a think tank, an accounting office, an auditing corporation, etc. For this reason, client enterprises make separate requests for individual services. Such conventional management consultation or audit has often relied upon a group sharing links or upon mutual confidences which may lie between managers of the service beneficial enterprises and service providers making management consultation or audit. In this case, the service providers have experimentally grasped the realities of the beneficiary enterprises. Secret information on the beneficiary enterprises has also been disclosed depending on circumstances, although such information has been returned to the beneficiary enterprises after completion of the consultation or auditing. The service beneficiary enterprises on the other hand have various special systems and employ persons in charge for administrative affairs such as personnel affairs, general affairs, accounting affairs, sales administration and production control, to make proposals for management consultation, auditing, etc., or execute pointed items or follow-up. Depending on their powers, a limited range of in-house secret information is imparted to the persons in charge for administrative affairs such as personnel affairs, accounting affairs and general affairs, of the beneficiary enterprises. Moreover, the service beneficiary enterprises often utilize their respective packaged softwares for the computer systems executing the administrative affairs such as the personnel affairs, accounting affairs, sales administration and production control. For this reason, the administrative departments about the personnel affairs, accounting affairs, general affairs, etc., keep persons in charge who are familiar with packaged software used so that requests from the service providers for materials to be investigated can readily be dealt with.

In recent business management, however, the service beneficiary enterprises tend toward outsourcing of administrative affairs such as personnel affairs, accounting affairs and general affairs which are not involved directly with production activities or sales activities. This means that there may be no persons in charge effecting the execution and follow-up in spite of reception of proposals for consultation or audit pointed items from the service providers. In particular, the service beneficiary enterprises have a tendency toward acceptance from ASPs (Application Service Providers) of the systems for administrative affairs such as personnel affairs, accounting affairs and general affairs. The ASPs deal with services for providing various applications to clients by way of networks. The ASPs are expected to become widespread due to its low initial costs, quick system rise, labor saving operation and simple manipulation. However, the ASP service includes storing and managing the client information in the server-side database, and hence it would be difficult to readily obtain a sense of confidence and security of the clients for the ASPs irrespective of all possible security measures.

### SUMMARY OF THE INVENTION

It is therefore an object of the present invention to provide a business management support method and a business management support program capable of providing consulting information suited for the users.

Another object of the present invention is to provide a business management support method and a business management support program available for utilization of ASPs through simultaneous provision of the ASP services and support services.

A further object of the present invention is to provide a business management support method and a business management support capable of promoting their prevalence with enhanced feeling of confidence and security for the ASP services by providing the business management support services through intermediaries in the form of banks with which service beneficiaries have dealings.

According to a first aspect of the present invention there is provided a business management support method in which computers of a service provider, a service beneficiary, a service intermediary and an intellectual service cooperator are connected via a network with one another, the method comprising an information collecting step which includes collecting enterprise information from the computer of the service beneficiary; a requesting step which includes providing the collected enterprise information to the computer of the intellectual service cooperator to make a request for consultation; and an information providing step which includes posting the computer of the service intermediary on the results of consultation received from the computer of the intellectual service cooperator, and adding service intermediary transaction information to the results to create support information for provision to the service beneficiary.

In this event, the service intermediary is a bank which has dealings with the service beneficiary. The information collecting step includes collecting enterprise information of the service user input to the computer of the service provider and collecting enterprise information acquired from the computer of the service beneficiary through ASP service by which the computer of the service provider provides applications.

In this manner, the present invention allows the service provider to be an ASP service company which provides ASP services about personnel affairs, accounting affairs, general affairs, etc., and which intervenes between the service beneficiary and the intellectual service cooperator for providing intellectual services such as management consultation, going public business support, accounting audit and environmental audit and which, by way of a bank as the service intermediary, provides the management support service such as proposal and execution of consultation, and confirmation of status of execution of audited items. Follow is thus provided. For this reason, with the ASP services about administrative affairs such as the personnel affairs, accounting affairs and general affairs, the service beneficiary can accept the business support information such as the management consultation, going public business support, accounting audit and environmental audit, under the follow of the bank with which the service beneficiary has dealings. As a result, the ASP service is not a mere computer rental and can occupy an extremely important position in the management strategies, whereby the ASP can be expected to become rapidly prevalent. When viewed from the service provider, since the business support service is provided through the dealing bank, the information can be recognized as information backed up by the confidence of the dealing bank, whereby reliability and feeling of securities for the ASP service are remarkably improved so that the service can be utilized without any sense of congruity even though secret information of the service beneficiary lies on the database of the ASP service provider. Furthermore, in addition to the ordinary bank transaction services such as deposits and debts, the dealing bank as the service intermediary provides to the member enterprise the business support information such as the management consultation, going public business support, accounting audit and environmental audit, whereby it is possible to bring up and develop the member enterprise substantially beyond the frame of the services and to fully accept the benefits of expansion of transaction as the general bullion information service along with the development of the member enterprise which is the service beneficiary.

The information providing step may include providing on line enterprise support information created by the computer of the service intermediary to the computer of the service beneficiary, or alternatively may include outputting enterprise support information created by the computer of the service intermediary to a handheld terminal for service intermediary, for off-line provision to the service beneficiary. This enables the enterprise support information to positively utilized through the business activities of the bank, to provide a proper follow to the enterprise which is the service beneficiary. The information providing step may include setting flag information, e.g., professional service flag PSF into enterprise support information created by the computer of the service intermediary, the flag information permitting the service beneficiary to make access to the computer of the intellectual service beneficiary by way of the network to accept a direct support, i.e., accept provision of the consulting service. The flag information depends on the consulting contract concluded by way of the bank. When this flag information is set, the service beneficiary makes a direct access to the computer of the intellectual service provider such as the management consultant or auditing corporation which is the support information provider, to accept the direct support through the questions to and conferences with the person in charge.

In the business management support method of the present invention, depending on the predefined follow levels based on the contract, masking is effected in sequence on the collected enterprise information, enterprise information provided to the computer of the intellectual service cooperator, and the results of consultation to post the computer of the service beneficiary thereon. When the follow level is a maximum level, the enterprise information and the results of consultation are completely indicated without masking. When the follow level is a minimum level, masking is made on attribute information other than requisite items in the enterprise information and the results of consultation. When the follow level is a level lying between the maximum level and the minimum level, the attribute information is indicated partially or in a simplified manner. For this reason, although secret is contained in the enterprise information on the service beneficiary handled by the service provider, intellectual service cooperator and service intermediary, proper management of the secret information can be achieved by masking the secret information depending on e.g., five follow levels. In this event, the intellectual service cooperator may include an auditing corporation, a think tank, a securities firm and a capital gain company. The business management support service may include management diagnosis, support of going public business, support of publicity work for investors and support of various settlements.

According to a second aspect of the present invention there is provided a business management support program to be run by a computer of a service provider which is connected via a network with computers of a service beneficiary, a service intermediary and an intellectual service cooperator, the program comprising an information collecting step which includes collecting enterprise information from the computer of the service beneficiary; a requesting step which includes providing the collected enterprise information to the computer of the intellectual service cooperator to make a request for consultation; and an information providing step which includes posting the computer of the service intermediary on the results of consultation received from the computer of the intellectual service cooperator, and adding service intermediary transaction information to the results to create support information for provision to the service beneficiary. The details of this business management support program are substantially the same as those of the business management support method.

According to a third aspect of the present invention there is provided a business management support method to be effected by a computer of a service beneficiary which is connected via a network with computers of a service provider, a service intermediary and an intellectual service cooperator, the method comprising an information providing step which includes providing enterprise information in response to a request from the computer of the service provider; and

an information accepting step which includes accepting the results of consultation received from the computer of the intellectual service cooperator as a result of provision of the enterprise information thereto from the computer of the service provider, the results of consultation being accepted in the form of support information including service intermediary transaction information added to the results of consultation when the results go through the computer of the service intermediary.

The above and other objects, aspects, features and advantages of the present invention will become more apparent from the following detailed description when taken in conjunction with the accompanying drawings.

### BRIEF DESCRIPTION OF THE DRAWINGS

FIG. 1 is an explanatory diagram of a network environment to which the present invention is applied;

FIGS. 2A and 2B are block diagrams showing the functional configuration of a service providing server implementing a method of the present invention, together with another server;

FIG. 3 is an explanatory diagram of the contents of services provided by the present invention;

FIG. 4 is an explanatory diagram of the relationship of contract implementing the services of the present invention;

FIG. 5 is an explanatory diagram of digital contract information based on the consulting contract of FIG. 4;

FIG. 6 is an explanatory diagram of a contract record entered in a contract state database of FIG. 2;

FIG. 7 is an explanatory diagram of information provided for use in a request for personnel evaluation;

FIG. 8 is an explanatory diagram of a masking control table for use in mask processing of FIG. 7;

FIG. 9 is an explanatory diagram of information provided for use in a request for client analysis;

FIG. 10 is an explanatory diagram of a masking control table for use in mask processing of FIG. 9;

FIG. 11 is a flowchart of business management support services in accordance with the present invention;

FIGS. 12A and 12B are time charts of the management support services in accordance with the present invention; and

FIG. 13 is a flowchart of going public support processing provided as one of the management support services of the present invention.

### DETAILED DESCRIPTION OF THE PREFERRED EMBODIMENTS

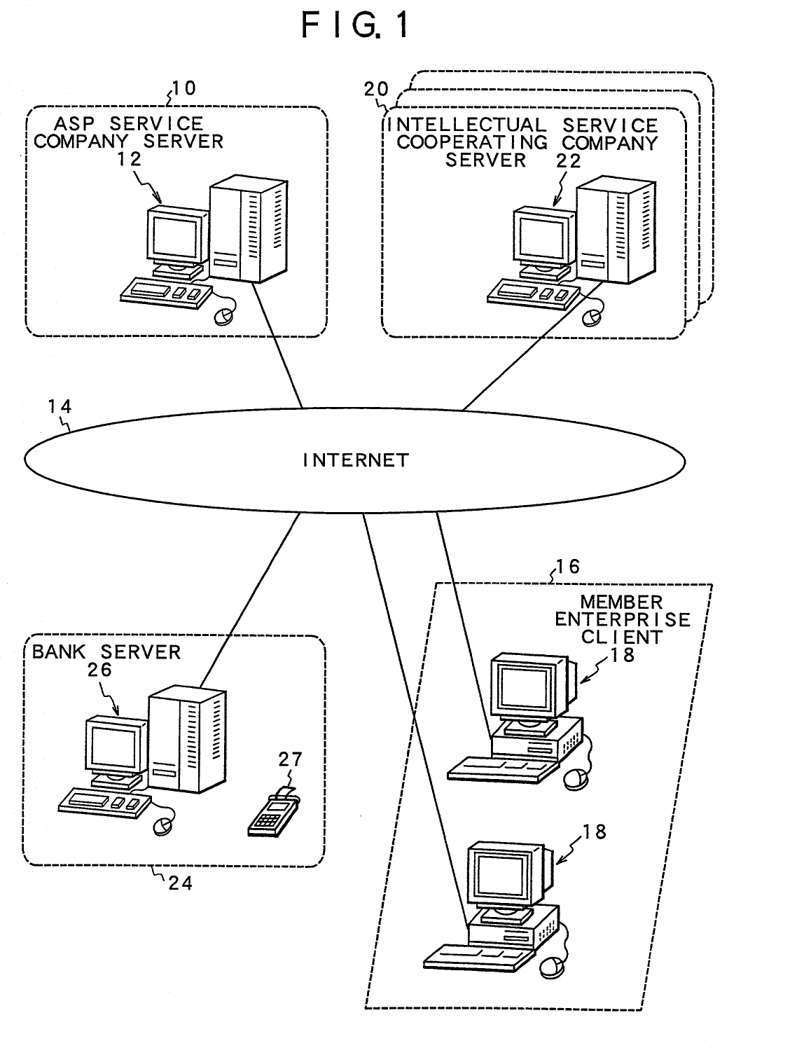

FIG. 1 is an explanatory diagram of a network system implementing a business management support method in accordance with the present invention. The business management support method of the present invention provides a support system comprising an ASP service company 10 which is a service provider acting as the central part of the system, a member enterprise 16 which is a service beneficiary, an intellectual service cooperating company 20 which is an intellectual service cooperator, and a bank 24 which is a service intermediary. The ASP service company 10 includes an ASP service company server 12. The member enterprise includes a member enterprise client 18. The intellectual service cooperating company 20 includes an intellectual service cooperating company server 22. The bank 24 includes a bank server 26 and a portable terminal 27 for the bank. The servers 12, 22 and 26 and the member enterprise client 18 are interconnected by way of an internet 14. The ASP service company 10 provides to the member enterprise 16 an ASP service in the form of a system for administrative affairs which are not involved with the production activities or sales activities, such as personnel affairs, accounting affairs and general affairs. Furthermore, in the present invention, the ASP service company 10 allows the member enterprise 16 to input enterprise information required for the consultation into the ASP service company server 12 on the basis of a consulting contract concluded. Simultaneously, the ASP service company 10 makes use of the enterprise information obtained by the ASP service for the member enterprise 16, to provide the enterprise information to the intellectual service cooperating company 20 to make a request for consultation. By way of thebank24, the ASP service company 10 provides to the member company 16 a management support service in the form of the results of consultation obtained from the intellectual service cooperating company 20. Upon provision of the results of consultation from the ASP service company 10 via the bank 24 to the member enterprise, the bank 24 as the service intermediary adds the service information on deposits or debts concerning the ordinary bank dealings between the bank 24 and the member enterprise 16 to the results of consultation posted from ASP service company 10, to thereby create bank follow information for the provision to the member enterprise 16. The bank follow information including the results of consultation from the bank 24 to the member enterprise 16 may be provided on line from the bank server 26 via the internet 14 to the member enterprise client 18. Alternatively, a person on outside duty of the bank 24 may carry the bank portable terminal 27 having bank follow information temporarily stored therein to the member enterprise 16 so that the bank follow information including the results of consultation can be provided from the bank portable terminal 27 to the member enterprise 16 through negotiations with a person in charge of the member enterprise 16.

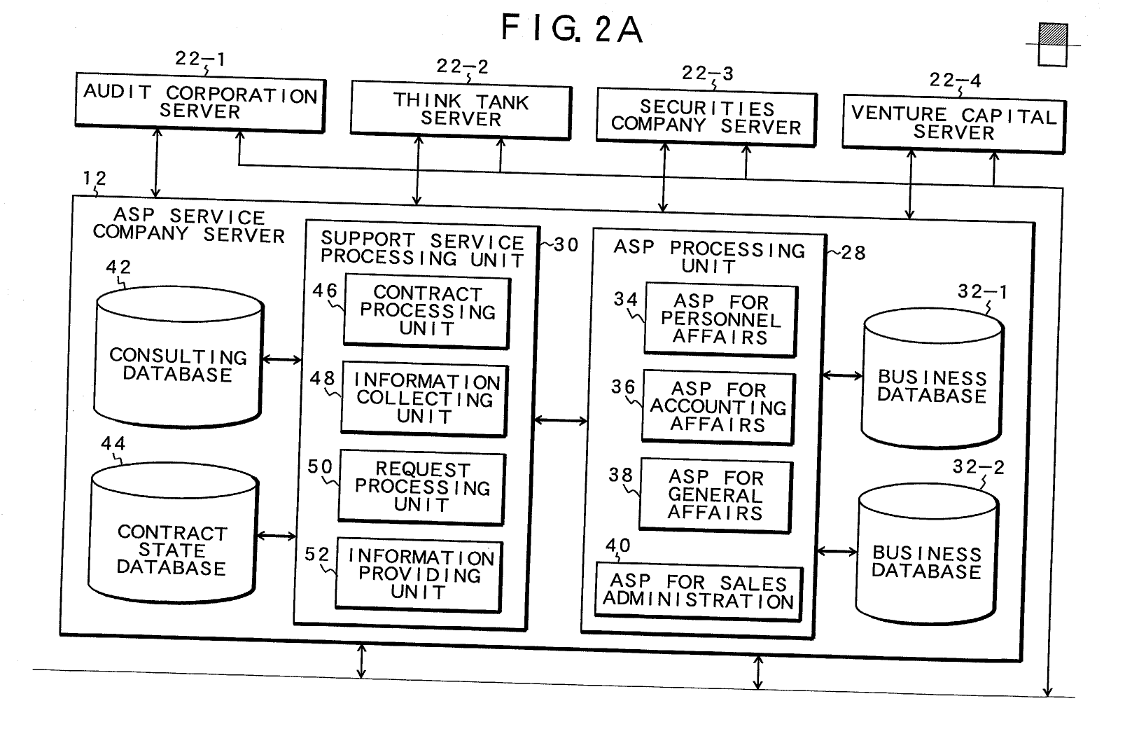

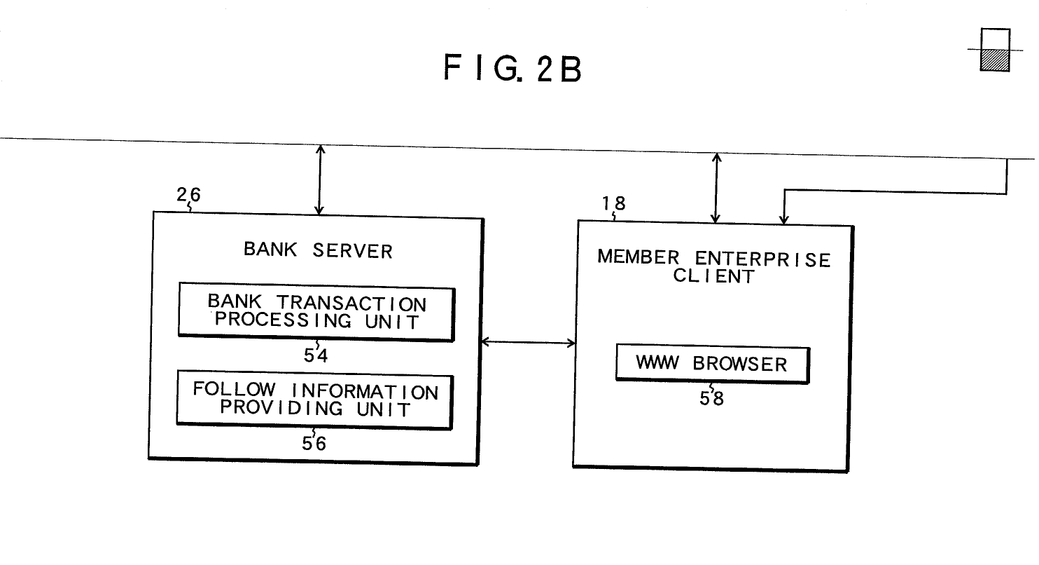

FIGS. 2A and 2B show the functional configuration of a service providing server which provides a business management support method implemented by the network system of FIG. 1, together with another server. The ASP service company server 12 comprises an ASP processing unit 28 and a support service processing unit 30. The ASP processing unit 28 includes for example an ASP 34 for personnel affairs, an ASP 36 for accounting affairs, an ASP 38 for general affairs and an ASP 40 for sales administration. The ASP processing unit 28 is associated with business databases 32-1 and 32-2 which store enterprise information on personnel affairs, accounting affairs, general affairs and sales administration of the member enterprise processed by the corresponding ASPs. In addition to such an ASP processing unit having existing functions, the support service processing unit 30 is newly provided for the present invention. The support service processing unit 30 includes a contract processing unit 46, an information collecting unit 48, a request processing unit 50 and an information providing unit 52. The contract processing unit 46 processes as digital information a consulting contract concluded between a member enterprise and an ASP service company for implementing the business management support service of the present invention and enters the contents of the contract into a contract state database 44. The information collecting unit 48 collects enterprise information required for the business management support service from various pieces of business information on the personnel affairs, accounting affairs, general affairs and sales administration stored in the business databases 32-1 and 32-2 as a result of ASP service provided from the ASP processing unit 28 to the member enterprise client 18. The information collecting unit 48 then stores the required enterprise information into a consulting database 42. The request processing unit 50 provides the thus collected enterprise information being stored in the consulting database 42 to an intellectual service cooperator's computer, e.g., an audit corporation server 22-1, a think tank server 22-2, a securities company server 22-3 or a venture capital server 22-4, to make a request for consultation in conformity with the contents of consulting contract. When receiving the results of consultation from the intellectual service cooperator's servers 22-1 to 22-4, the information providing unit 52 stores the results of consultation into the consulting database 2 and posts the bank server 26 acting as the service intermediary. The information providing unit 52 then causes the bank server 26 to create bank follow information and issues an instruction to provide the bank follow information including the results of consultation to the member client 18. The bank server 26 is provided with a bank transaction processing unit 54 and a follow information providing unit 56. The bank transaction processing unit 54 takes charge of processing related to the bank transactions such as deposits and debts which is ordinarily effected between the bank server 26 and the member enterprise client 18. The follow information providing unit 56 is newly provided and is attendant on the business management support service of the present invention. When accepting a notice of the results of consultation from the ASP service company server 12, the follow information providing unit 56 adds thereto the bank transaction information acquired by the bank transaction processing unit 54 to create bank follow information to notify the member enterprise client 18 thereof. The member enterprise client 18 is equipped with a www browser 58 so as to be able to accept the ASP service from the ASP service company server 12 and to further accept the business management support service of the present invention by way of the bank server 26. It is to be noted that acceptance of the business management support service in the member enterprise may be achieved off line by the person on outside duty using the bank portable terminal 27 as shown in FIG. 1 without being limited to the on-line acceptance of the bank follow information from the bank server 26.

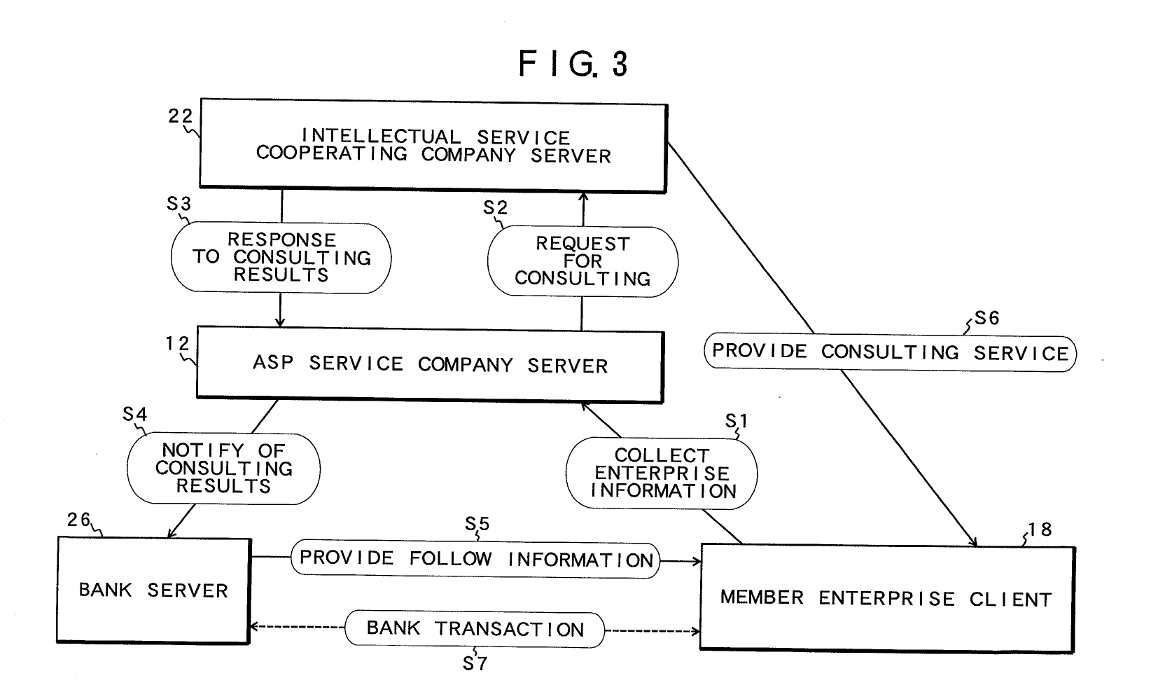

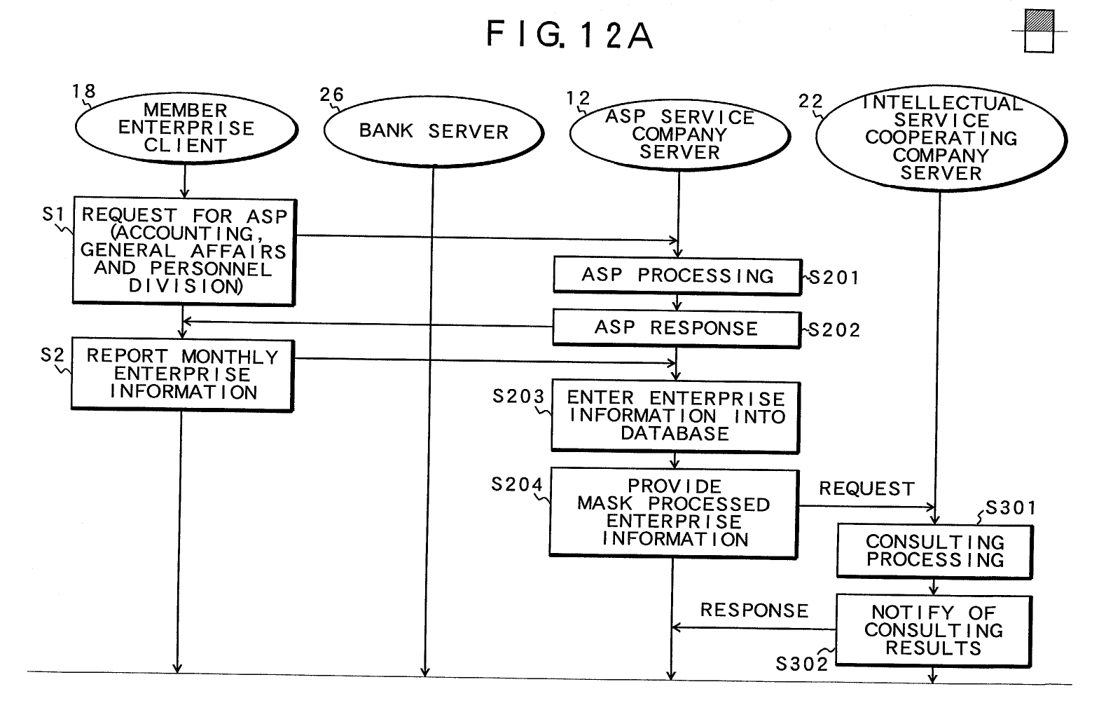

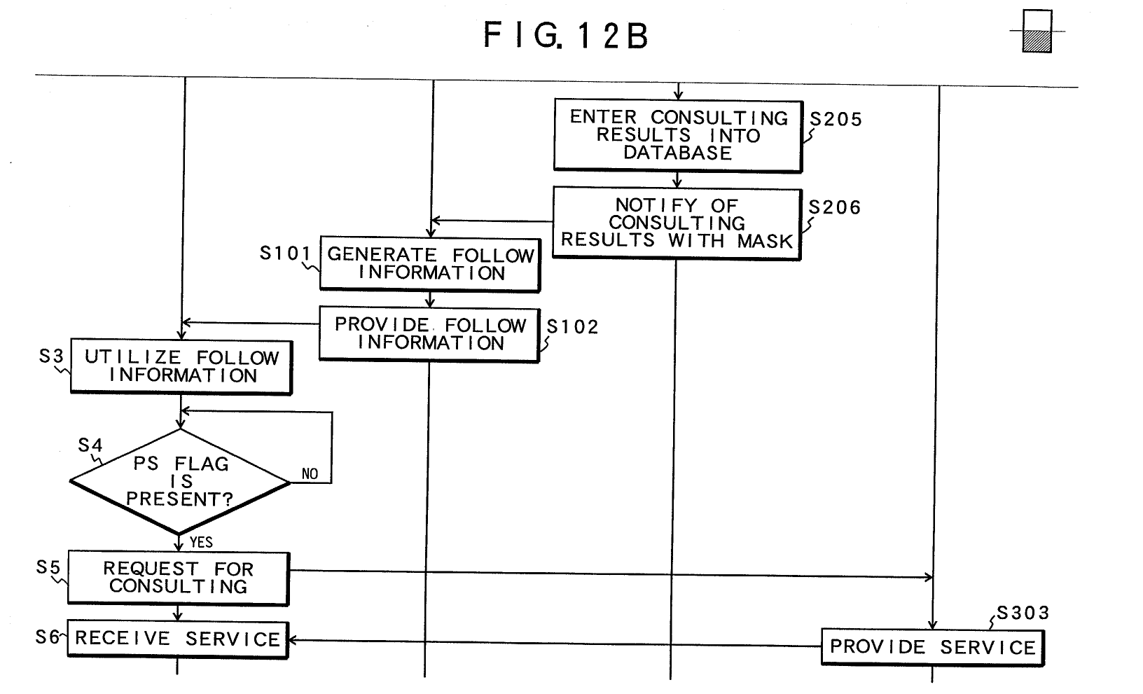

FIG. 3 is an explanatory diagram of the processing function of the business management support service of the present invention effected by the ASP service company server 12 of FIG. 12. Once a month, at the end of month for example, the ASP service company server 12 executes processing of the business management support service based on the consulting contract. First in step S1, the ASP service company server 12 collects enterprise information required for the consultation from the member enterprise client 18. In this case, upon the conclusion of the consulting contract, the person in charge of the ASP service company enters enterprise information required for the consultation of the member enterprise into the ASP service company server 12. For this reason, depending on the already entered enterprise information, the required enterprise information is collected from data stored in the business database 32-1 and 32-2 of the ASP service company server 12, which data have been collected as a result of the ASP service which may daily be provided between the ASP service company server 12 and the member enterprise client 18 as in FIG. 2. Naturally, the person in charge of the ASP service providing company enters the enterprise information required for the consultation of the member enterprise not only upon the conclusion of the consulting contract but also at any time when necessity arises. The ASP service company server 12 then sends the enterprise information collected in step S2 to the intellectual service cooperating company server 22 to make a request for consultation. Based on the contents of the consulting contract, the request for consultation is made to the intellectual service cooperating company server 22-1 to 22-4 such as the audit corporation server, think tank server, securities company server and venture capital server as shown in FIGS. 2A and 2B for example. When accepting a request for consultation from the ASP service company server 12, the intellectual service cooperating company server 22 uses the provided enterprise information to analyze the information, and in step S3 makes a response of the results of consultation including expert comments to the ASP service company server 12. The time from the request for the consultation to the response needs a certain period of time, e.g., one week after the request or ten days after the request. Once accepting the response of the results of consultation of step S3, the ASP service company server 12 notifies the bank server 26 of the results of consultation in step S4. When accepting the notice of the results of consultation, the bank sever 26 combines the bank information obtained from the ordinary bank transactions of step S7 with the results of consultation to create bank follow information, and in step S5 provides the bank follow information to the member enterprise client 18. The bank follow information contains flag information called a professional service flag which corresponds to the contents of the consulting contract. When the flag information is on and valid, the member enterprise client 18 makes a direct access based on the flag information to the intellectual service cooperating company server 22 which has issued the results of consultation, to accept the provision of the consulting service as in step S6.

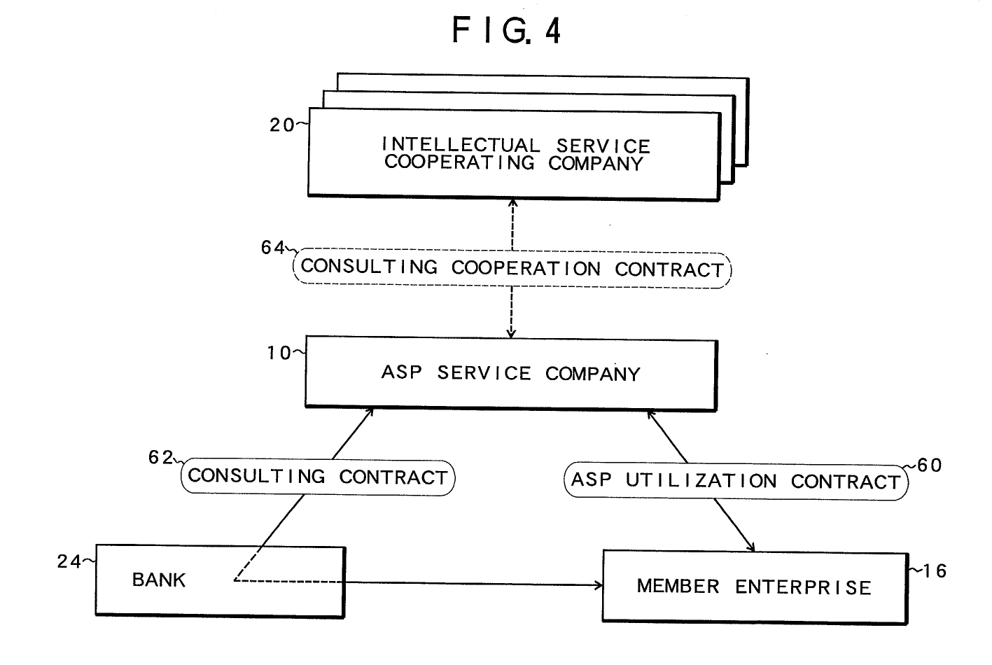

FIG. 4 is an explanatory diagram of a consulting contract for realizing the business management support service in accordance with the present invention as in FIG. 3. The ASP service company 10 and the member enterprise 16 conclude a consulting contract 62 for providing a business management support service to the member enterprise 16 by way of the bank 24. An ASP utilization contract 60 is also concluded between the ASP service company 10 and the member enterprise 16. A consulting cooperation contract 64 is in advance concluded between the ASP service company 10 and the intellectual service cooperating company 20.

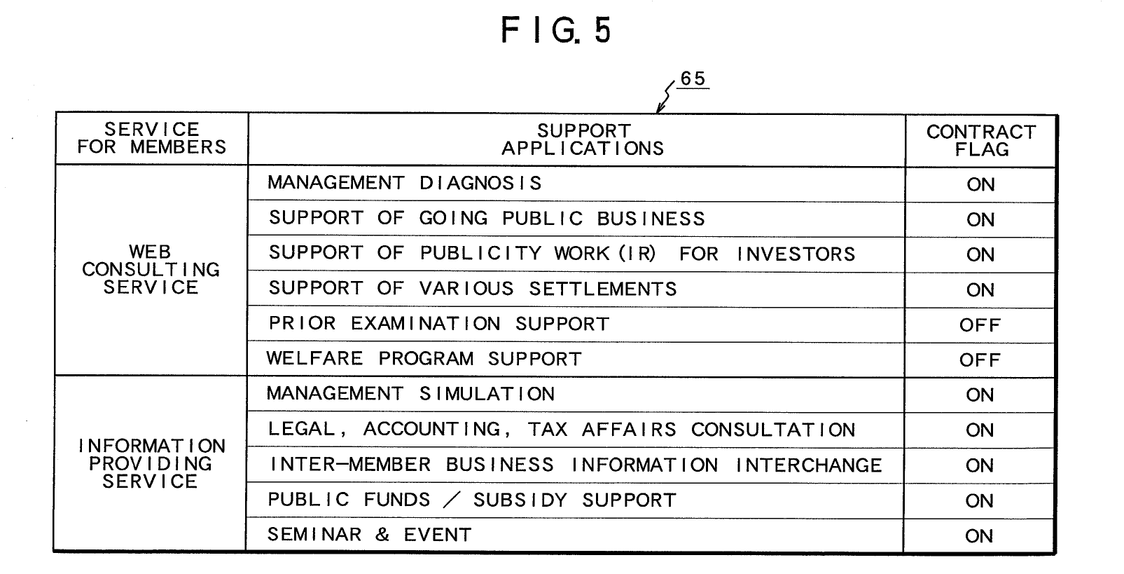

FIG. 5 shows an example of digital contract information 65 based on the consulting contract 62 of FIG. 4. The digital contract information 65 consists of a service for members, a support application and a contract flag. The service for members includes

(I) Web consulting service; and

(II) information providing service.

Of the two, the Web consulting service is at the core of the business management support service in accordance with the present invention, and the information providing service is an additional service. The Web consulting service can include for example

(I) management diagnosis;

(II) support of going public business;

(III) support of publicity work (IR) for investors;

(IV) support of various settlements;

(V) prior examination support;

(VI) welfare program support. The contract flag determines the presence or absence of the consulting contract 62 concluded between the ASP service company 10 and the member enterprise 16 of FIG. 4. The contract flag of a contracted support application is ON and the contract flag of an uncontracted support application is OFF. In this example, the contract flags are ON of the four support applications for management diagnosis, support of going public business, support of publicity work for investors and support of various settlements so that services are provided by the support applications having the active contract flags. The information providing service has support applications for management simulation, legal, accounting, tax affairs consultation, inter-member business information interchange, public funds/subsidy support and seminar & event, of which contract flags are all ON in principle, allowing all the member enterprises to accept the full information providing service. It is also natural to turn off the contract flags of unnecessary information providing services. Upon the conclusion of the consulting contract 62, there may be set, if the member enterprise desires, a consultant follow level indicative of the degree of disclosure of information at the execution of each consultation and a professional service flag indicative of whether a direct access is to be made to the intellectual service cooperating company 20 for conference.

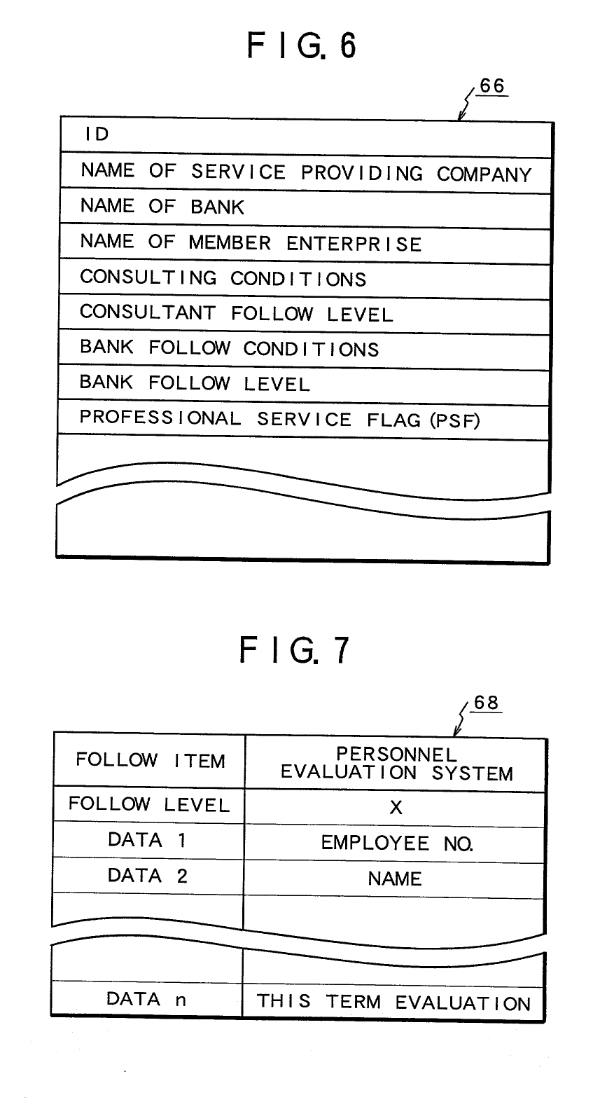

FIG. 6 is an explanatory diagram of a contract record 66 which is actually entered into the contract state database 44 of the ASP service company server 12 of FIG. 2 on the basis of the digital contract information 65 of FIG. 5. The contract record 66 includes an ID acting as an index, name of service providing company, name of bank, and name of member enterprise, which is followed by consulting conditions indicative of the contents of the support applications of the Web consulting services and the information providing services, whose contract flags are ON in conformity with the digital contract information 65 of FIG. 5 based on the consulting contract. For the consulting conditions there is provided the consultant follow level based on information specified upon the conclusion of the consulting contract 62. The consultant follow level provides a control of the degree of disclosure of the secret information contained in the enterprise information which is provided when the ASP service company server 12 makes a request for consultation to the intellectual service cooperating company 22 in FIG. 3. The follow level can have five different levels, e.g., from the minimum level 1 to the maximum level 5 depending on the degree of secret. The next bank follow conditions define conditions of bank information to be added to the results of consultation when the bank server 26 accepts the notice of the results of consultation from the ASP service company server 12 as in FIG. 3, e.g., conditions of bank information on deposits, debts, etc.,

in the bank transaction. The next bank follow level provides a control of the degree of disclosure to the bank of the secret information of the member enterprise contained in the results of consultation posted from the ASP service company server 12. Similar to the consultant follow level, this bank follow level can have five different levels e.g., from the minimum level 1 to the maximum level 5 if necessary. A professional service flag (PSF) is further provided. The professional service flag is combined with the results of consultation so that if the professional service flag is ON, the member enterprise client 18 which has accepted the provision of the bank follow information as in FIG. 3 can make a direct access for the results of consultation to the intellectual service cooperating company server 22 to directly obtain the conference, explanation and provision of materials for the results of consultation.

FIG. 7 exemplarily shows the enterprise information upon the request for consultation of the personnel evaluation system, as an example of the data structure of the enterprise information which is provided from the ASP service company server 12 to the intellectual service cooperating company server 22 upon the request for the consultation. Enterprise information 68 for use in the request for consultation of the personnel evaluation has a personnel evaluation system as a follow item, which is followed by the contents of enterprise information including follow levels X=1 (minimum) to 5 (maximum), one of which is selected. The follow level X is followed by data 1 bearing employee No., data 2 bearing name, . . . , and data n bearing this term evaluation.

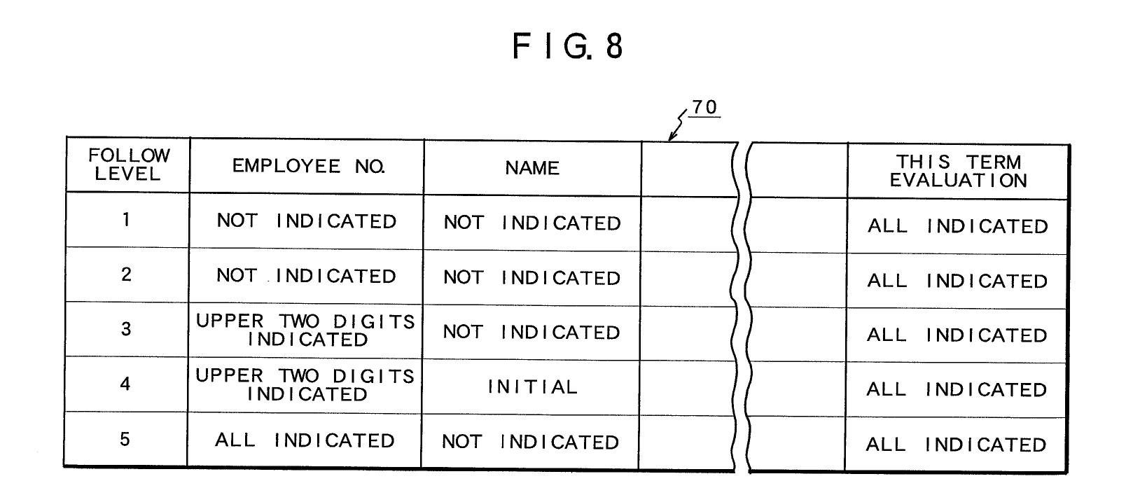

FIG. 8 is an explanatory diagram of a masking control table 70 corresponding to the follow levels X=1 to 5 for use in mask processing of the enterprise information 68 of FIG. 7. The masking control table 70 defines the contents of control of what degree of indication is to be made in conformity with the value of the follow level X of the items of the employee No. name, . . . , and this term evaluation corresponding to the follow levels 1 to 5. That is, the follow level indicates the degree of secret to be kept from the other party to which the enterprise information is provided. The follow level has a low follow level when the secret is desired to be kept but has a high follow level when there is no need to keep the secret. For example, in case the secret is desired to be fully kept from the other party to which the enterprise information is provided, the maximum follow level 1 is set. In this case, only this term evaluation is indicated with no indication of the employee No. and name. On the contrary, in the event that the secret information may be disclosed to the other party to which the enterprise information is provided, the maximum follow level 5 is set. The follow level 5 allows the employee No., name and this term evaluation to be all indicated. The follow level 3 allows a part of specific information to be indicated. For example, upper two digits are indicated of the employee No., with no indication of name and all indication of this term evaluation. The follow level 4 allows the name to have a somewhat loosened degree of disclosure of the secret, e.g., to be indicated by the initials, in addition to the upper two-digit indication of the employee No.

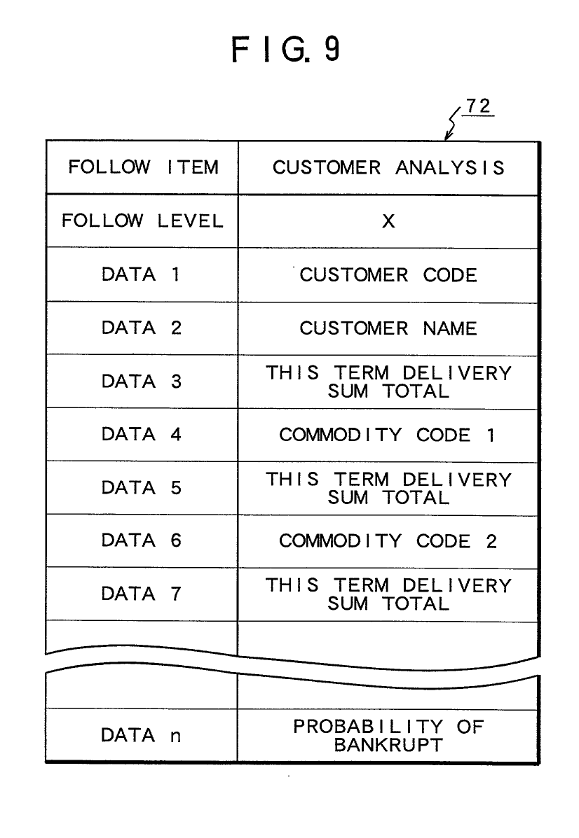

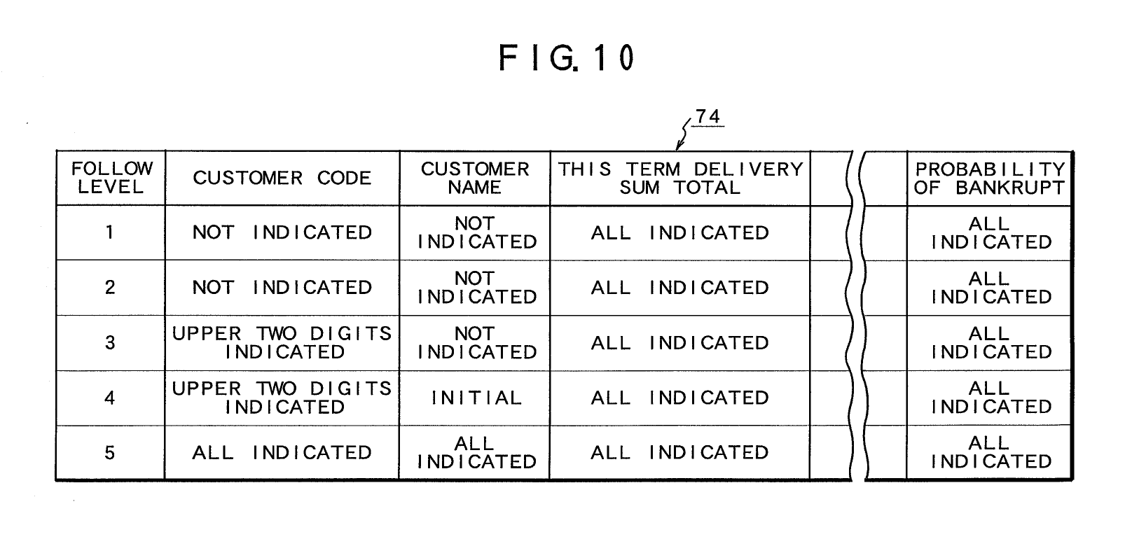

FIG. 9 shows the enterprise information 72 in the form of enterprise information for use in customer analysis by way of example. This enterprise information for the customer analysis sets customer analysis as the follow item, which is followed by follow level X and data 1 to 7 including customer code, customer name, this term delivery sum total, commodity code 1, this term delivery sum total, commodity code 2 and this term delivery sum total, and final data n bearing probability of bankrupt. A masking control table 74 of FIG. 10 is defined in such a manner as to correspond to the follow level X of the enterprise information 72 for this customer analysis. The masking table 74 defines the contents of control from not indicated to all indicated about information items of customer code, customer name, this term delivery sum total, . . . , and probability of bankrupt by use of five states of the follow levels 1 to 5.

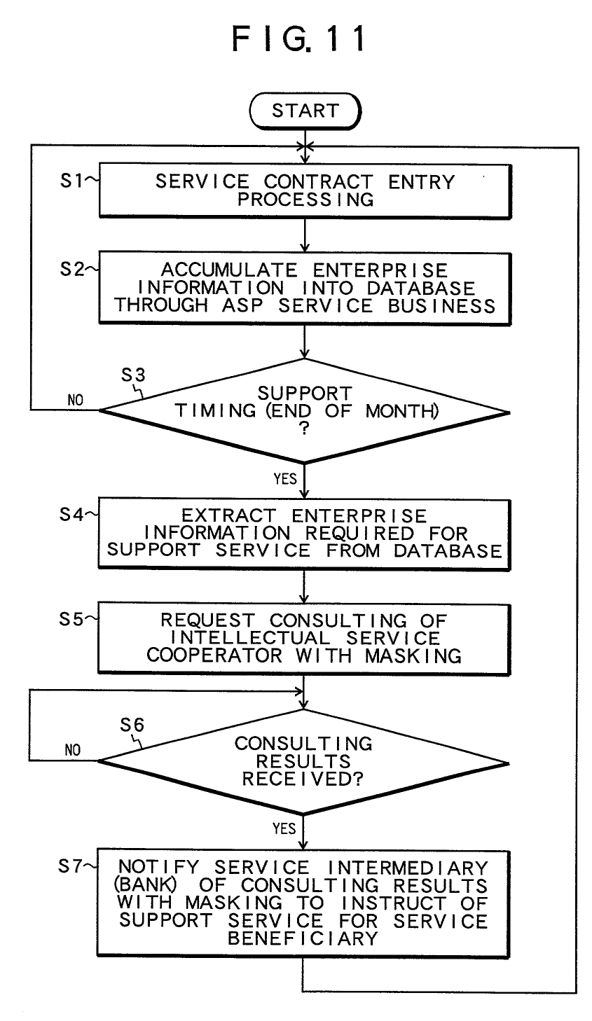

FIG. 11 is a flowchart of the business management support service processing of the present invention effected by the support service processing unit 30 included in the ASP service company server 12 of FIG. 2. First, in step S1, digital contract information is input on the basis of the consulting contract to execute the service contract entry processing into the contract state database 44. Then, in step S2, the enterprise information is accumulated into databases 32-1 and 32-2 through the ASP service business effected by the ASP processing unit 28. A check is made in step S3 to see if it is the timing to process the support service, e.g., it is the last day of a month. If the support service timing is judged, then the procedure goes to step S4 where enterprise information required for the support service is extracted from the business databases 32-1 and 32-2, with enterprise information appropriately input from the member enterprise being added to the thus extracted enterprise information, which in turn is saved in the consulting database 42. Then, in step S5, a request for consulting is made to the server of the intellectual service cooperating company with the collected enterprise information masked in conformity with the follow level of the contents of contract. In step S6, receipt is waited of the results of consultation from the intellectual service cooperating company, and if the consulting results are received, then the procedure goes to step S7 where the masking dependent on the follow level is performed on the basis of the results of consultation. Then the bank server as the service intermediary is posted on the results of consultation so that the bank server 26 can create follow information by adding the bank transaction information thereto, to designate the support service to be provided to the service beneficiary which is the member enterprise together with the consulting results.

FIGS. 12A and 12B are time charts time sequentially showing the processings effected by each server and client in the business management support service of the present invention in FIG. 2. The member enterprise client 18 makes a request for the ASP service about the accounting affairs, general affairs, personnel affairs, etc., to the ASP service company server 12 in step S1. In response to this, the ASP service company server 12 executes the ASP processing requested in step S201 by use of the ASP processing unit 28 and makes a response of the results of ASP processing to the member enterprise client 18 in step S202. When the member enterprise client 18 judges that the support service timing, e.g. , the end of a month has been reached in step S2 in the state where such a daily ASP service is being performed, it makes a report of monthly performance information to the ASP service company server 12. In response to this, the information collecting unit 48 of the ASP service company server 12 extracts enterprise information required for the consultation from the business database for ASP and enters the enterprise information into the consulting database 42 in step S203. This consulting database 42 has already stored therein enterprise information required for consultation of the member enterprise appropriately input to the ASP service providing company server 12 upon e.g., the conclusion of the consulting contract 62. Then, in step S204, the request processing unit 50 provides to the intellectual service cooperating company server 22 the enterprise information which is extracted by the information processing unit 48 and which has experienced mask processing depending on the follow level, to thereby make a request for consultation. In response to this request, the intellectual service cooperating company server 22 performs the consultation processing in step S301 and makes a response to notify the ASP service company server 12 of the results of consultation in step S302. Upon receipt of the response of results of consultation, the information providing unit 52 of the ASP service company server 12 enters the results of consultation into the consulting database 42 in step S205, and then refers to the contract record 66 entered in the contract state database 44 in S206 to notify the bank server 26 of the results of consultation with mask which has undergone mask processing depending on the follow level and of the contents of the professional service flag. When accepting the notice of the results of consultation, the follow information providing unit 56 of the bank server 26 adds bank information obtained by the bank transaction processing unit 54 through the ordinary bank transaction to the results of consultation to thereby create bank follow information in step S101 and then provides the bank follow information to the member enterprise client 18 in step S102. When accepting the bank follow information containing the results of consultation from the bank server 26 in step S3, the member enterprise client 18 makes use of this bank follow information for various enterprise activities, i.e., examination of management strategies attendant on the results of management diagnosis, going public preparing work attendant on the support of going public business, publicity work based on the support of publicity work for investors. If it is judged in step S4 that the professional service flag is set in the bank follow information, then a direct request for consultation about the results of consultation can be made to the intellectual service cooperating company server 22 in step S5. In response to this request for consultation from the member enterprise client 18, the intellectual service cooperating company server 22 allows the person in charge of the enterprise of the member enterprise client 18 to accept explanation and conference about the results of consultation from the expert of the intellectual service cooperating company server 22 in an interactive form in step S303. Provision of service in step S303 and the acceptance of service in step S6 are thus effected.

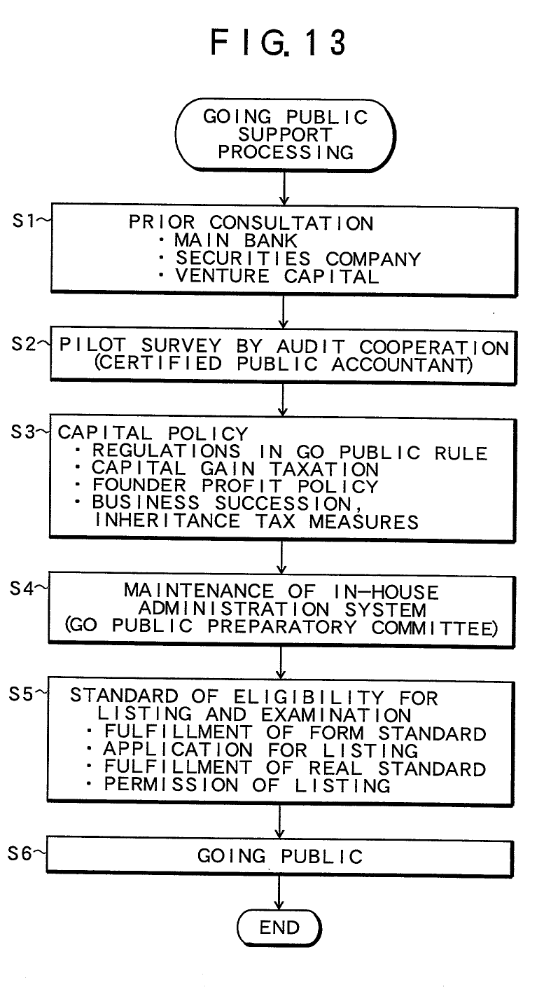

FIG. 13 is a flowchart of support processing upon the going public support business carried out by the ASP service company server 12. In the business management support service of the present invention, the going public support business service is provided to an unlisted middle-scaled enterprise in conformity with the flowchart of FIG. 13. A prior consultation is first carried out as the initial processing of the going public support processing in step S1. It is necessary for the manager of the member enterprise desiring to accept the going public support business service through the business management support service of the present invention to positively examine the possibility of going public of its own company. To this end, the ASP service company server 12 of the present invention transmits the will of going public of the member enterprise to the main banks, securities firms, venture capitals, etc., and makes a request for consultation of whether the going public is proper or not or of possibility of realization, to provide the results of consultation to the member enterprise. For suitable decision making of the going public there is a need for broad professional knowledge such as various rules and tax laws about going public. Through prior conference with the securities firm positively inviting to go public of its own company, the venture capital providing going public support and further the main bank, it is possible to select the most advantageous timing to go public and the capital policy. If the prior conference has been complete in step S1, then the audit corporation (certified public accountant) provides the support service of pilot survey in step S2. When the will of the member enterprise to go public has been settled to some extent, the member enterprise needs to undergo the pilot survey of the audit corporation (certified public accountant). In the pilot survey, the audit corporation (certified public accountant) having broad knowledge and experience for the general going public gives a general survey of the actual situation of the member enterprise, the problem to the achievement of the going public, suitable going public schedule, etc., and makes a report of the results of survey to the member enterprise. Various support services required for this pilot survey are provided to the member enterprise. Then in step S3 a support service for the capital policy is carried out. The capital policy is a generic term of various measures on corporate stocks effected prior to the going public, and support services about regulations in the go public rule, capital gain taxation, founder profit measures, business succession, inheritance tax measures are provided by the experts of the audit corporation, think tank, securities firm, venture capital, etc., to the member enterprise. A support service is then provided for the maintenance of in-house administrative system in step S4. The support service for the maintenance of in-house administrative system includes examination of whether the systematic operation of enterprise like go public enterprise is made as a result of department from the private operation of enterprise. More specifically, support services for the in-house system maintenance are provided about the establishment of the system, administrative systems of various business affairs, maintenance of in-house regulations, management plan, benefit plan and budget control, internal audit system, stock works, maintenance of related companies, guarantee of quality system and going public. Then, a support service for standard of eligibility for listing and examination is provided in step S5. The standard of eligibility for listing usually includes a form standard and a real standard. A check is first made to see if the form standard is fulfilled or not in this relationship between the standard and the examination. If affirmative, then application for listing is made and it is judged whether the real standard is fulfilled or not with respect to the application for listing. If affirmative, then permission of listing is obtained. The application for listing is made through such a support service for the standard of eligibility for listing and examination, to finally achieve going public in step S6. As to the support service of going public support processing of FIG. 13 as well, the present invention is characterized in that the provision of the support service from the ASP service company server 12 to the member enterprise 16 is constantly carried out by way of the bank 24 acting as the service intermediary. As to the going public in particular, the bank 24 as the service intermediary is regarded as a main bank so that the support service of the going public is provided to the member enterprise under the substantial leadership of the bank which provides a powerful backup in financial affairs. Through the business management support service of the present invention, the ASP service company can gain profits of the following items by the provision of the service.

(I) Consignment fee from affiliated bank;

(II) Membership fee from member enterprise;

(III) Various introduction fees attendant on support service such as a success fee attendant on the going public business support; and

(IV) Support fee about design and monitoring of the IT system.

The present invention further provides a computer readable record medium having thereon recorded a business management support program which is executed by a computer of a service provider, specifically by the ASP service company server 12, the service provider's computer being connected via a network to computers of the service beneficiary, the service intermediary and the intellectual service cooperator, to provide business support service to the service beneficiary in cooperation with the service intermediary and the intellectual service cooperator. Referring for example to FIG. 1, the business management support program stored in the record medium provided by the present invention allows the execution of:

(I) an information collection step which includes collecting and saving enterprise information from the member enterprise client 18 of the member enterprise 16 which is a service beneficiary;

(II) a request step which includes providing the collected enterprise information to the intellectual service cooperating company server 22 to thereby make a request for consultation; and

(III) an information providing step which includes notifying the bank server 26 acting as the service intermediary of the results of consultation received from the intellectual service cooperating company server 22, to allow the bank server to create bank follow information managing the bank transaction information which is the service intermediary transaction information, for provision to the member enterprise. The business management support program recorded on the record medium of the present invention is installed as the support service processing unit 30 of FIG. 2 in the ASP service company server 12 and is created as an application program operating on Windows (R) for example. This business management support program is stored in a carriable storage medium such as a CD-ROM, a floppy (R) disk, a DVD, a magneto-optical disk and an IC card or is installed via a modem or a LAN interface from database or other computer system into a computer in the form of the ASP service company server 12 of FIG. 3. The computer installed business management support program of the present invention is recorded on the hard disk HDD and is run by the CPU by use of a RAM.

Although the above embodiment has been directed to the example where the bank was the service intermediary of the business management support service, the present invention is not limited thereto, but may employ, as the intermediary, an appropriate enterprise such as the securities firm, consulting company, venture capital, etc., other than the bank closely related to the business management. Although the above embodiment has been directed to the support for the business management, the application based support service related to the business management may include various support services for employees of the member enterprise, such as, specifically, welfare for employees, personal loans, 401K, internet banking. The present invention is not limited to the above embodiments, but can include any appropriate variants without impairing its objects and advantages. The present invention is not restricted by numerical values shown in the above embodiments.

According to the present invention, as set forth hereinabove, the ASP service company as the service provider provides to the member enterprise the results of consultation of the member enterprise which the service intermediary such as the audit corporation has been requested to make, think tank and securities firm, in the form of bank follow information with bank information added to the results of consultation through a bank as the service intermediary, whereby proper consulting information can be provided to the member enterprise as the user, which enhances the value added of the ASP service, allowing a rapid prevalence thereof.

The business support service from the ASP service providing company is provided through a bank with which deals the member enterprise as the service beneficiary, with the result that the business support service can be recognized as one backed up by the trust of its dealing bank, which will contribute to a remarkably improved reliability and feeling of securities. Thus, even though the secret information of the member enterprise as the service beneficiary lies on the database of the ASP service provider, the ASP service can be utilized without any sense of incongruity.

Furthermore, in addition to the ordinary bank transaction services such as deposits and debts, the dealing bank as the service intermediary provides to the member enterprise the bank follow information in the form of the business support information such as the management consultation, going public business support, accounting audit and environmental audit, combined with the bank transaction information, whereby it is possible to bring up and develop the member enterprise beyond the frame of the services based on only the bank business affairs and to fully accept the benefits of expansion of transaction as the general bullion information service along with the development of the member enterprise which is the service beneficiary.

Although the secret information contained in the enterprise information of the member enterprise is provided to the ASP service providing company which is the service provider, the intellectual service cooperating company which performs a consultation, and further to the bank as the service intermediary, enterprise information masked depending on the follow level is provided to the enterprise information acceptor by setting the follow level for controlling the degree of disclosure of the secret information upon the first contract, whereby it is possible to appropriately protect, as not open, secret information in the enterprise information which is particularly unnecessary for the acceptor. For this reason, even the enterprise information containing the secret information can be provided to the acceptor which regards it as sufficiently necessary information for the consultation for the business management support service, whereupon the free operation of the enterprise information can ensure a smooth consulting work for more appropriate enterprise management support.

What is claimed is:

1. A business management support method in which computers of a service provider, a service beneficiary, a service intermediary and an intellectual service cooperator are connected via a network with one another, said method comprising:
an information collecting step which includes collecting enterprise information from said computer of said service beneficiary;
a requesting step which includes providing said collected enterprise information to said computer of said intellectual service cooperator to make a request for consultation; and
an information providing step which includes posting said computer of said service intermediary on the results of consultation received from said computer of said intellectual service cooperator, and adding service intermediary transaction information to said results to create support information for provision to said service beneficiary.

2. The method according to claim 1, wherein said service intermediary is a bank which has dealings with said service beneficiary.

3. The method according to claim 1, wherein said information collecting step includes collecting enterprise information of said service user input to said computer of said service provider and collecting enterprise information acquired from said computer of said service beneficiary through ASP (Application Service Provider) service by which said computer of said service provider provides applications.

4. The method according to claim 1, wherein said information providing step includes providing on line enterprise support information created by said computer of said service intermediary to said computer of said service beneficiary.

5. The method according to claim 1, wherein said information providing step includes outputting enterprise support information created by said computer of said service intermediary to a handheld terminal for service intermediary, for off-line provision to said service beneficiary.

6. The method according to claim 1, wherein said information providing step includes setting flag information into enterprise support information created by said computer of said service intermediary, said flag information permitting said service beneficiary to make access to said computer of said intellectual service beneficiary by way of said network to accept a direct support.

7. The method according to claim 1, wherein depending on predefined follow levels, masking is effected in sequence on enterprise information collected in said information collecting step, enterprise information provided to said computer of said intellectual service cooperator in said requesting step, and the results of consultation on which said computer of said service beneficiary is posted in said information providing step.

8. The method according to claim 7, wherein when said follow level is a maximum level, said enterprise information and said results of consultation are completely indicated without masking, and wherein when said follow level is a minimum level, masking is made on attribute information other than requisite items in said enterprise information and said results of consultation, and wherein when said follow level is a level lying between said maximum level and said minimum level, said attribute information is indicated partially or in a simplified manner.

9. The method according to claim 1, wherein said intellectual service cooperator includes an auditing corporation, a think tank, a securities firm and a capital gain company.

10. The method according to claim 1, wherein said business management support service includes management diagnosis, support of going public business, support of publicity work for investors and support of various settlements.

11. A business management support program to be run by a computer of a service provider which is connected via a network with computers of a service beneficiary, a service intermediary and an intellectual service cooperator, said program comprising:
an information collecting step which includes collecting enterprise information from said computer of said service beneficiary;
a requesting step which includes providing said collected enterprise information to said computer of said intellectual service cooperator to make a request for consultation; and
an information providing step which includes posting said computer of said service intermediary on the results of consultation received from said computer of said intellectual service cooperator, and adding service intermediary transaction information to said results to create support information for provision to said service beneficiary.

12. A computer readable record medium having thereon recorded a business management support program to be run by a computer of a service provider which is connected via a network with computers of a service beneficiary, a service intermediary and an intellectual service cooperator, said program comprising:
an information collecting step which includes collecting enterprise information from said computer of said service beneficiary;
a requesting step which includes providing said collected enterprise information to said computer of said intellectual service cooperator to make a request for consultation; and
an information providing step which includes posting said computer of said service intermediary on the results of consultation received from said computer of said intellectual service cooperator, and adding service intermediary transaction information to said results to create support information for provision to said service beneficiary.

13. A business management support system having a network via which computers of a service provider, a service beneficiary, a service intermediary and an intellectual service cooperator are connected with one another, said system comprising:
an information collecting unit which collects enterprise information from said computer of said service beneficiary;
a requesting unit which provides said collected enterprise information to said computer of said intellectual service cooperator to make a request for consultation; and
an information providing unit which posts said computer of said service intermediary on the results of consultation received from said computer of said intellectual service cooperator, said information providing unit adding service intermediary transaction information to said results to create support information for provision to said service beneficiary.

14. A business management support method to be effected by a computer of a service beneficiary which is connected via a network with computers of a service provider, a service intermediary and an intellectual service cooperator, said method comprising:
an information providing step which includes providing enterprise information in response to a request from said computer of said service provider; and
an information accepting step which includes accepting the results of consultation received from said computer of said intellectual service cooperator as a result of provision of said enterprise information thereto from said computer of said service provider, said results of consultation being accepted in the form of support information including service intermediary transaction information added to said results of consultation when said results go through said computer of said service intermediary.

15. A business management support system implemented by a computer of a service beneficiary which is connected via a network with computers of a service provider, a service intermediary and an intellectual service cooperator, said system comprising:
an information providing unit which provides enterprise information in response to a request from said computer of said service provider; and
an information accepting unit which accepts the results of consultation received from said computer of said intellectual service cooperator as a result of provision of said enterprise information thereto from said computer of said service provider, said results of consultation being accepted in the form of support information including service intermediary transaction information added to said results of consultation when said results go through said computer of said service intermediary.
